(19) United States
(12) Patent Application Publication
(10) Pub. No.: US 2023/0019810 A1
(43) Pub. Date: Jan. 19, 2023

(54) METHOD FOR MANUFACTURING EXTRUDED MATERIAL OF ALUMINUM-CARBON NANOTUBE COMPOSITE WITH IMPROVED CORROSION RESISTANCE AND EXTRUDED MATERIAL OF ALUMINUM-CARBON NANOTUBE COMPOSITE MANUFACTURED THEREBY

(71) Applicant: PUKYONG NATIONAL UNIVERSITY INDUSTRY-UNIVERSITY COOPERATION FOUNDATION, Busan (KR)

(72) Inventor: Hansang Kwon, Busan (KR)

(21) Appl. No.: 17/935,517

(22) Filed: Sep. 26, 2022

Related U.S. Application Data
(63) Continuation of application No. PCT/KR2020/006646, filed on May 21, 2020.

(30) Foreign Application Priority Data
Mar. 27, 2020 (KR) 10-2020-0037537

(51) Int. Cl. B21C 23/00; C22C 21/00; C22C 26/00; C25D 11/08; C25D 11/10; B22F 9/04; B22F 3/105

(52) U.S. Cl. CPC B21C 23/002; C22C 21/00; C22C 26/00; C25D 11/08; C25D 11/10; B22F 9/04; B22F 3/105; C22C 2026/002; C22C 2204/00; B22F 2009/043; B22F 2003/1051

(57) ABSTRACT

A method of manufacturing an extruded material of carbon nanotube reinforced aluminum matrix composite having improved corrosion resistance, and the extruded material manufactured thereby are proposed. The method may include manufacturing an extruded material comprising an aluminum-carbon nanotube composite material and forming a hard oxide film on the surface of the extruded material by anodizing the extruded material in a mixed solution of sulfuric acid and oxalic acid. The method can form a hard oxide film with excellent corrosion resistance, abrasion resistance, and insulation properties on the surface of a composite material (an extruded material of carbon nanotube reinforced aluminum matrix composite material), which is known to be difficult to conduct hard anodizing due to the difference in corrosion characteristics between materials and, accordingly, the usability of the composite material can be significantly improved.

### CROSS-REFERENCE TO RELATED APPLICATIONS

This application is a continuation application, and claims the benefit under 35 U.S.C. § 120 and § 365 of PCT Application No. PCT/KR2020/006646, filed on May 21, 2020, which claims priority to Korean Patent Application No. 10-2020-0037537 filed on Mach 27, 2020, both of which are hereby incorporated by reference in their entirety.

### BACKGROUND

### Technical Field

The present disclosure relates to a method for manufacturing an extruded material of carbon nanotube reinforced aluminum matrix composite having improved corrosion resistance, and the extruded material manufactured thereby.

### Description of Related Technology

Aluminum and aluminum alloys have excellent malleability and ductility, so they can be processed into virtually any shape such as bar, tube, plate, foil, and wire. The extrusion process is mainly used to obtain products with a constant cross-section, such as rods, tubes, and wires.

### SUMMARY

One aspect is a method for manufacturing an extruded material of carbon nanotube reinforced aluminum matrix composite having durability that can be used in various extreme environments (such as seawater environment accompanied by high corrosion and radiation or harmful substances environment) and the extruded material manufactured thereby.

Another aspect is a method of manufacturing an extruded material of aluminum-carbon nanotube composite with improved corrosion resistance, the method comprising: (a) manufacturing an extruded material comprising an aluminum-carbon nanotube composite material; and (b) forming a hard oxide film on the surface of the extruded material by anodizing the extruded material in a mixed solution of sulfuric acid and oxalic acid.

The step (a) may comprise the steps of (i) preparing a composite powder by ball-milling aluminum alloy powder and carbon nanotubes powder; (ii) preparing a multi-layered billet using the composite powder; and (iii) extruding the multi-layered billet, in which the multi-layered billet comprises a core layer and at least two shell layers surrounding the core layer, the shell layers except for the outermost shell layer are made of the composite powder and the outermost shell layer is made of a pure metal or an alloy, and the composite powders in the core layer and each of the shell layer have different compositions.

In addition, in the method, the multi-layered billet may comprise a first billet having a can shape and serving as the second shell layer; a second billet disposed inside the first billet as the first shell layer; and a third billet disposed inside the second billet as the core layer.

In addition, in the step (ii), the preparing of the multi-layered billet may comprise subjecting the composite powder to spark plasma sintering performed at a pressure of 30 to 100 MPa and a temperature of 280° C. to 600° C. for a duration of 1 second to 30 minutes.

In addition, in the step (iii), the multi-layered billet can be extruded using an indirect extrusion process, a direct extrusion process, a hydrostatic extrusion process, or an impact extrusion process.

In addition, in the step (b), the mixed solution may be an aqueous solution containing 1 to 5% by volume of sulfuric acid and 5 to 20% by volume of oxalic acid.

In addition, in the step (b), the extruded material may be anodized with a current of a density of 1 to 10 A/dm² at room temperature to 60° C.

Another aspect is an extruded material of aluminum-carbon nanotube composite manufactured by the method described above.

The manufacturing method according to the present disclosure is capable of forming a hard oxide film with excellent corrosion resistance, abrasion resistance, and insulation properties on the surface of a composite material (an extruded material of carbon nanotube reinforced aluminum matrix composite material), which is known to be difficult to conduct hard anodizing due to the difference in corrosion characteristics between materials and, accordingly, the usability of the composite material can be significantly improved.

### BRIEF DESCRIPTION OF THE DRAWINGS

FIG. 1 is a flowchart illustrating a method of manufacturing an extruded material of aluminum-carbon nanotube composite according to one embodiment of the present disclosure.

FIG. 2 is a diagram schematically illustrating a billet preparation process.

FIG. 3 is a perspective view schematically illustrating an example of a multi-layered billet.

### DETAILED DESCRIPTION

In order to improve the physical properties of an aluminum or aluminum alloy extruded material and expand its application range, it is necessary to improve corrosion resistance, mechanical properties, workability, etc. by making composite materials of aluminum or aluminum alloy with a different material.

For example, extruded materials of carbon nanotube-reinforced aluminum matrix composite material in which carbon nanotube (CNT) is used as a reinforcing material and composited with aluminum or aluminum alloy matrix can be designed as a customized material having properties such as ultra-light, high strength, and high heat dissipation according to its use.

However, in order to be able to use the extruded material of carbon nanotube-reinforced aluminum matrix composite material in harsh environments (such as seawater environments accompanied by high corrosion and radiation or hazardous substances environments), the durability of the material through additional improvement of corrosion resistance and reliability is required.

In describing embodiments of the present disclosure, well-known functions or constructions will not be described in detail when they may obscure the gist of the present disclosure.

Embodiments in accordance with the concept of the present disclosure can undergo various changes to have various forms, and only some specific embodiments are illustrated in the drawings and described in detail in the present disclosure. While specific embodiments of the present disclosure are described herein below, they are only for illustrative purposes and should not be construed as limiting to the present disclosure. Accordingly, the present disclosure should be construed to cover not only the specific embodiments but also cover all modifications, equivalents, and substitutions that fall within the concept and technical spirit of the present disclosure.

The terminology used herein is for the purpose of describing particular embodiments only and is not intended to limit the scope of the present disclosure. As used herein, the singular forms “a”, “an”, and “the” are intended to include the plural forms as well unless the context clearly indicates otherwise. It will be further understood that the terms “comprises”, “includes”, or “has” when used in the present disclosure specify the presence of stated features, regions, integers, steps, operations, elements and/or components, but do not preclude the presence or addition of one or more other features, regions, integers, steps, operations, elements, components and/or combinations thereof.

Hereinafter, embodiments of the present disclosure will be described.

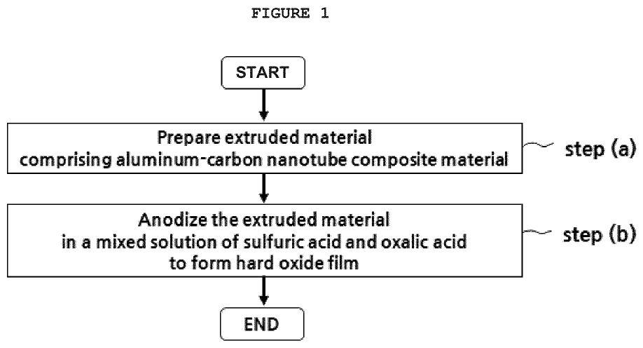

A manufacturing method according to one embodiment of the present disclosure includes the steps of (a) manufacturing an extruded material comprising an aluminum-carbon nanotube composite material; and (b) forming a hard oxide film on the surface of the extruded material by anodizing the extruded material in a mixed solution of sulfuric acid and oxalic acid (FIG. 1).

First, in the step (a), an extruded material including a carbon nanotube-reinforced aluminum matrix composite material is prepared.

As an example, this step (a) comprises the steps of (i) preparing a composite powder by ball-milling aluminum alloy powder and carbon nanotubes powder; (ii) preparing a multi-layered billet using the composite powder; and (iii) extruding the multi-layered billet, in which the multi-layered billet comprises a core layer and at least two shell layers surrounding the core layer, the shell layers except for the outermost shell layer are made of the composite powder and the outermost shell layer is made of a pure metal or an alloy, and the composite powders in the core layer and each of the shell layer have different compositions.

In the step (i), the aluminum alloy powder is powder of any one aluminum alloy selected from the group consisting of 1000 series, 2000 series, 3000 series, 4000 series, 5000 series, 6000 series, 7000 series, and 8000 series.

Since the composite powder contains the carbon nanotubes, the aluminum-based clad heat sink made of the composite powder is light and has high thermal conductivity and strength. Thus, this heat sink is very useful as a heat dissipation member for various electronic parts and lighting devices.

When preparing the composite powder, there are problems that micro-sized aluminum or aluminum alloy particles are difficult to disperse due to a large size difference from nano-sized carbon nanotubes and the carbon nanotubes easily agglomerate by a strong Van der Waals force. Therefore, a dispersion agent is added to uniformly blend the carbon nanotubes and the aluminum particles or aluminum alloy particles.

The dispersion agent is a nano-sized ceramic selected from the group consisting of nano-SiC, nano-SiO₂, nano-Al₂O₃, nano-TiO₂, nano-Fe₃O₄, nano-MgO, nano-ZrO₂, and mixtures thereof.

The nano-sized ceramic particles uniformly disperse the carbon nanotubes among the aluminum particles or aluminum alloy particles. Since the nano-sized silicon carbide (SiC) has high tensile strength, sharpness, constant electrical conductivity, constant thermal conductivity, high hardness, high fire resistance, high resistance to a thermal shock, and high chemical stability at high temperatures, it is widely used as an abrasive or a fireproofing agent. In addition, the nano-sized SiC particles present on the surfaces of the aluminum particles have a function of preventing direct contact between the carbon nanotubes and the aluminum particles or aluminum alloy particles to inhibit formation of undesirable aluminum carbide which is formed through reaction between the carbon nanotubes and the aluminum particles or aluminum alloy particles.

The composite powder may include 100 parts by volume of the aluminum powder or aluminum alloy powder and 0.01 to 10 parts by volume of the carbon nanotubes.

When the content of the carbon nanotubes is less than 0.01 part by volume with respect to 100 parts by volume of the aluminum powder or aluminum alloy powder, the strength of a composite material made from the composite powder is similar to that of a pure aluminum or an aluminum alloy. That is, in that range of the content of the carbon nanotubes, the carbon nanotubes cannot play a role as a reinforcing material. Conversely, when the content exceeds 10 parts by volume, there is a disadvantage in that an elongation decreases although the strength of a composite material made from the composite powder is higher than that of a pure aluminum or aluminum alloy. In addition, when the content of the carbon nanotubes is excessively large, the carbon nanotubes hinder dispersion of the aluminum particles and degrade mechanical and physical properties of the product by serving as defect sites.

When the dispersion agent is included in the composite powder, the composite powder contains 0.1 to 10 parts by volume of the dispersion agent with respect to 100 parts by volume of the aluminum powder.

When the content of the dispersion agent is less than 0.1 part by volume with respect to 100 parts by volume of the aluminum powder, the dispersion inducing effect is insignificant. Conversely, when the content exceeds 10 parts by volume, the dispersion agent rather hinders dispersion of the aluminum particles because it causes the carbon nanotubes to agglomerate.

A horizontal or planetary ball mill is used for the ball milling. The ball milling is performed in a nitrogen or argon ambient at a low speed ranging from 150 to 300 rpm or a high speed of 300 or more rpm for a duration of 12 to 48 hours.

The ball milling begins by charging 100 to 1500 parts by volume of stainless steel balls (a 1:1 mixture of balls with a diameter of 10 mm and balls with a diameter of 20 mm) into a stainless steel container with respect to 100 parts by volume of the composite powder.

To reduce the coefficient of friction, any one organic solvent selected from the group consisting of heptane, hexane, and alcohol is used as a process control agent. In this case, the process control agent is added by 10 to 50 parts by volume with respect to 100 parts by volume of the composite powder. After the completion of the ball milling, the stainless steel container is opened so that the organic solvent can be volatilized, leaving only a mixture of the aluminum powder and the carbon nanotubes.

The dispersion agent (herein, nano-sized ceramic particles) plays the same role as nano-sized milling balls due to the rotational force generated during the ball milling, thereby physically separating the agglomerated carbon nanotubes from each other and improving the fluidity of the carbon nanotubes. Thus, the carbon nanotubes can be uniformly dispersed on the surfaces of the aluminum particles.

Next, a multi-layered billet is made from the obtained composite powder in the step (ii).

The multi-layered billet produced in this step comprises a core layer and at least two shell layers surrounding the core layer. The shell layers except for the outermost shell layer are made of the composite powder. The outermost shell layer is made of (i) the aluminum or aluminum alloy powder or (ii) the composite powder. The composite powders contained in the core layer and each of the shell layers have different volume parts of carbon nanotubes with respect to a predetermined volume part of the aluminum or aluminum alloy powder.

The number of the shell layers included in the multi-layered billet is not particularly limited, but it is preferably 5 or less in terms of cost efficiency.

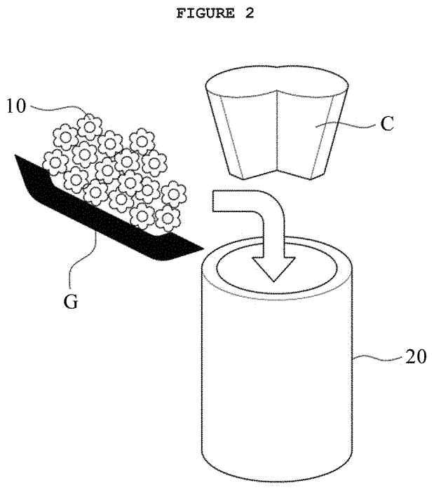

FIG. 2 is a diagram schematically illustrating a multi-layered billet preparation process.

Referring to FIG. 2, the billet is prepared by charging the composite powder 10 into a metal can 20 through a guider G.

The metal can 20 is closed with a cap C or the composite powder in the metal can 20 is compressed so that the composite power cannot flow out of the metal can 20. The metal can 20 is made of any metal being thermally and electrically conductive. Preferably, the metal can 20 is made of aluminum, copper, or magnesium. The thickness of the metal can 20 ranges from 0.5 to 150 mm when a 6-inch billet is used, but it varies depending on the size of the billet used.

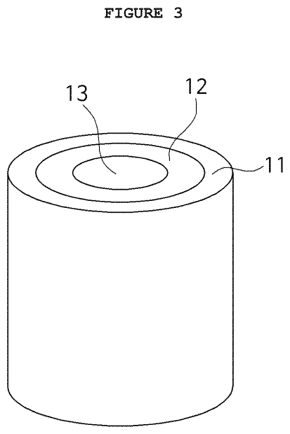

FIG. 3 is a diagram illustrating an example of the multi-layered billet. The example of the multi-layered billet includes a core layer and two shell layers surrounding the core layer. Specifically, the multi-layered billet includes a core layer, a first shell layer surrounding the core layer, and a second shell layer surrounding the first shell layer.

Referring to FIG. 3, a second billet 12 serving as the first shell layer is disposed in a first billet 11 having a hollow cylindrical shape, serving as the second shell layer (i.e., the outermost shell layer), and made of a material having a composition different from that of the second billet, and a third billet 13 having a composition different from that of the second billet 12 is disposed in the second billet 12 as the core layer to form the multi-layered billet.

The first billet 11 has a hollow cylindrical shape. That is, the first billet 11 is in the form of a can with one end closed or in the form of a hollow cylinder with both ends being open. The first billet 11 is made of aluminum, copper, magnesium, or the like. The first billet 11 having a hollow cylinder shape is manufactured by melting a base metal and injecting molten metal into a mold. Alternatively, it can be manufactured by machining a metal block.

The second billet 12 includes the prepared composite powder. The second billet 12 is in the form of a mass or powder.

When the second billet 12 is in the form of a mass, the second billet 12 specifically has a cylinder shape. The composite billet is prepared by placing the cylindrical second billet 12 in the first billet 11. To prepare the multi-layered billet in which the second billet 12 is placed in the first billet 11, the composite powder to form the second billet 12 is melted, the molten material is injected into a mold to form a cylindrical shape, and the cylindrical shape is press-fitted into the first billet 11. Alternatively, the composite powder is directly charged into the cavity of the first billet 11.

The third billet 13 is a metal mass or metal powder.

When the second billet 12, the third billet 13, or both are in the form of a mass of the composite powder, the mass of the composite powder is produced by compressing the composite powder at a high pressure or sintering the composite powder.

In this case, the composite powder of the second billet 12 and the composite powder of the third billet 13 have different volume parts of the carbon nanotubes with respect to 100 parts by volume of the aluminum power or the aluminum alloy powder. For example, the composite powder of the second billet 12 contains 0.09 to 10 parts by volume of the carbon nanotubes with respect to 100 parts by volume of the aluminum or aluminum alloy powder, and the composite powder of the third billet contains 0 to 0.08 part by volume of the carbon nanotubes with respect to 100 parts by volume of the aluminum or aluminum alloy powder.

Alternatively, the second billet 12 is made of the composite powder, and the third billet 13 is a metal mass or powder selected from the group consisting of aluminum, copper, magnesium, titanium, stainless steel, tungsten, cobalt, nickel, tin, and alloys thereof.

Of the total volume of the composite billet, the second billet accounts for 0.01 to 10 vol %, the third billet accounts for 0.01 to 10 vol %, and the first billet 11 accounts for the rest.

On the other hand, since the second billet or the third billet of the multi-layered billet is made of the composite powder, the multi-layered billet is compressed at a high pressure of 10 to 100 MPa before being enclosed.

Since the multi-layered billet is compressed, it is possible to extrude the multi-layered billet using an extrusion die in the next step. When the pressure for compressing the composite powder is less than 10 MPa, there is a possibility that pores occur in the manufactured composite material and the composite powder flows down. When the pressure exceeds 100 MPa, the second billet (meaning second and onward billets) is likely to expand.

Further, since the second billet and/or the third billet of the multi-layered billet is made of the composite powder, a process of sintering the multi-layered billet may be performed to enable extrusion of the multi-layered billet.

A spark plasma sintering apparatus or a hot press sintering is used for the sintering in the invention. However, any sintering apparatus can be used as long as the same object can be achieved. However, when it is necessary to precisely sinter the multi-layered billet in a short time, it is preferable to use discharge plasma sintering. In this case, the discharge plasma sintering is performed at a temperature of 280° C. to 600° C. and a pressure of 30 to 100 MPa for a duration of 1 second to 30 minutes.

Subsequently, in the step (iii), a multi-layer billet is extruded to prepare an extruded material including an aluminum-carbon nanotube composite material.

A specific method for performing the extrusion process in this step is not particularly limited, and for example, the extrusion process may be performed by an indirect extrusion process, a direct extrusion process, a hydrostatic extrusion process, or an impact extrusion process

In addition, the shape of the extruded material manufactured through this step is not particularly limited, and may have various shapes, such as a rod, a pipe, a square material, and a plate.

In the step (b), an oxide film is formed through an anodizing process on the surface of the extruded material including the aluminum-carbon nanotube composite material prepared as described above.

Preferably, in this step, after disposing the extruded material as an anode in an aqueous solution containing 1 to 5% by volume of sulfuric acid and 5 to 20% by volume of oxalic acid as an electrolyte, anodizing is conducted with a current of 1 to 10 A/dm² at a temperature of room temperature to 60° C. to form a hard oxide film with a thickness of 100 μm or more on the surface of the extruded material.

Meanwhile, in this step, a pretreatment process such as electrolytic polishing or chemical polishing may be performed in order to remove impurities, remove scratches and secure flatness on the surface of the extruded material according to necessity prior to the anodizing process. In addition, after performing the pretreatment, a desmut process of activating the surface of the extruded material by removing smut remaining after etching or cleaning from the surface of the extruded material subjected to the pretreatment using chromic acid or the like may be performed.

In addition, after the anodizing is completed, a sealing process for blocking pores generated on the surface of the extruded material having a hard oxide film during the anodizing process may be performed if necessary. As an example of the sealing process, the extruded material having a hard oxide film is immersed in hot water and then maintained for a certain period of time to remove pores formed on the surface of the extruded material.

The manufacturing method according to the present disclosure described in detail above is capable of forming a hard oxide film with excellent corrosion resistance, abrasion resistance, and insulation properties on the surface of a composite material (an extruded material of carbon nanotube reinforced aluminum matrix composite material), which is known to be difficult to conduct hard anodizing due to the difference in corrosion characteristics between materials and, accordingly, the usability of the composite material can be significantly improved.

The present disclosure has been described in detail with reference to examples. Examples according to the present disclosure can be modified in various other forms, and the scope of the present disclosure is not construed as being limited to the examples described below. Examples are provided to more fully describe the present disclosure to the ordinarily skilled in the art.

The manufacturing method according to the present disclosure is capable of forming a hard oxide film with excellent corrosion resistance, abrasion resistance, and insulation properties on the surface of a composite material (an extruded material of carbon nanotube reinforced aluminum matrix composite material), which is known to be difficult to conduct hard anodizing due to the difference in corrosion characteristics between materials and, accordingly, the usability of the composite material can be significantly improved.

What is claimed is:

1. A method of manufacturing an extruded material of aluminum-carbon nanotube composite with improved corrosion resistance, the method comprising:
manufacturing an extruded material comprising an aluminum-carbon nanotube composite material; and
forming a hard oxide film on the surface of the extruded material by anodizing the extruded material in a mixed solution of sulfuric acid and oxalic acid.

2. The method according to claim 1, wherein the manufacturing comprises:
preparing a composite powder by ball-milling aluminum alloy powder and carbon nanotubes powder;
preparing a multi-layered billet using the composite powder; and
extruding the multi-layered billet,
wherein the multi-layered billet comprises a core layer and at least two shell layers surrounding the core layer,
wherein the shell layers except for the outermost shell layer are made of the composite powder and the outermost shell layer is made of a pure metal or an alloy, and
wherein the composite powders in the core layer and each of the shell layer have different compositions.

3. The method according to claim 2, wherein the multi-layered billet comprises:
a first billet having a can shape and serving as the second shell layer;
a second billet disposed inside the first billet as the first shell layer; and
a third billet disposed inside the second billet as the core layer.

4. The method according to claim 2, wherein the preparing of the multi-layered billet comprises subjecting the composite powder to spark plasma sintering performed at a pressure of 30 to 100 MPa and a temperature of 280° C. to 600° C. for a duration of 1 second to 30 minutes.

5. The method according to claim 2, wherein the multi-layered billet is extruded using an indirect extrusion process, a direct extrusion process, a hydrostatic extrusion process, or an impact extrusion process.

6. The method according to claim 1, wherein the mixed solution comprises an aqueous solution containing 1% to 5% by volume of sulfuric acid and 5% to 20% by volume of oxalic acid.

7. The method according to claim 1, wherein the extruded material is anodized with a current of a density of 1 A/dm² to 10 A/dm² at room temperature to 60° C.

8. An extruded material of aluminum-carbon nanotube composite manufactured by the method of claim 1.
